(19) United States
(12) Patent Application Publication
(10) Pub. No.: US 2010/0228766 A1
(43) Pub. Date: Sep. 9, 2010

(54) QUEUE MESSAGE RETRIEVAL BY SELECTION CRITERIA

(75) Inventor: Bret W. Dixon, South Perth (AU)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: International Business Machines Corporations, Armonk, NY (US)

(21) Appl. No.: 12/474,497

(22) Filed: May 29, 2009

Related U.S. Application Data
(63) Continuation-in-part of application No. 12/391,176, filed on Feb. 23, 2009.

(51) Int. Cl. G06F 17/30; G06F 7/00

(52) U.S. Cl. 707/769; 707/E17.014

(57) ABSTRACT

Embodiments of the present invention address deficiencies of the art in respect to message queuing and provide a method, system and computer program product for message queue retrieval by selection criteria. In an embodiment of the invention, a method for message queue retrieval by selection criteria can include receiving from a requesting application a message retrieval request for a message in a message queue storing different messages and determining from the message retrieval request both a template defining fields in the messages, and also selection criteria operable upon content stored in at least one of the fields in the messages. The method also can include applying the selection criteria to the messages in the message queue to select a message or subset of the messages in the message queue, and transmitting the message or subset to the requesting application.

### CROSS-REFERENCE TO RELATED APPLICATIONS

This patent application claims the benefit under 35 U.S.C. §120 as a continuation-in-part of presently pending U.S. patent application 12/391,176, entitled DATA SUBSET RETRIEVAL FROM A QUEUED MESSAGE, filed on Feb. 24, 2009, the entire teachings of which are incorporated herein by reference.

### BACKGROUND OF THE INVENTION

1. Field of the Invention

The present invention relates to the field of message queuing and more particularly to message retrieval from a message queue.

2. Description of the Related Art

In the field of information technology, a message queue is a software-engineering component used for inter-process communications or inter-thread communications. The component employs a queue into which messages can be placed by a messenger and from which messages can be retrieved by a designated recipient. In this regard, the message queue can be a communicative component enabling asynchronous messaging as between the messenger and the designated recipient. Operationally, the message queue can support multiple messengers and recipients such that asynchronous communications can be achieved for a group of participants.

The asynchronous nature of the message queue provides for an ideal technology coupler for disparate technologies. Specifically, so long as separate technologies can access the message queue, the separate and disparate technologies can engage in message passing thereby enabling communications. In particular, the message queue can expose different method calls through an application programming interface (API) for opening, writing to, reading from, and closing the message queue. Each application in turn can include logic to invoke a sequence of the method calls in order to either place a message into the message queue, or to retrieve a message from the message queue. Specifically, in operation, upon request, the API can search a message queue for an available message and can return the same to the requesting logic.

In the typical message queue, client applications retrieve messages from the queue in a variety of ways, for example according to first-in first-out principals, message prioritization principals and the like. Further, in that a message header often is stored in connection with a message in a message queue, data within the message header can be used to determine which message to retrieve from the queue. By way of example, the message header often is in the form of a data structure with fields describing aspects of the message such as a message identifier, a message group or a message sequence number.

Existing queuing technologies, however, cannot perform retrieval of a message based upon the content of the message itself. Rather, existing queuing technologies remain wholly dependant upon the description of the fields in a message disposed within a message header, or headers, for the message. In fact, existing queuing technologies remain devoid of logic enabled to analyze any content of the message itself for the purpose of particular selection and retrieval. Consequently, for an application to retrieve a message based on its content, the application must retrieve messages sequentially from the queue and examine each the message's content to determine whether the message is of interest or not.

### BRIEF SUMMARY OF THE INVENTION

Embodiments of the present invention address deficiencies of the art in respect to message queuing and provide a novel and non-obvious method, system and computer program product for message queue retrieval by selection criteria. In an embodiment of the invention, a method for message queue retrieval by selection criteria can include receiving from a requesting application a message retrieval request for a message in a message queue storing different messages and determining from the message retrieval request both a template defining fields in the messages, and also selection criteria operable upon content stored in at least one of the fields in the messages. The method also can include applying the selection criteria to the messages in the message queue to select a message or a subset of the messages in the message queue, and transmitting the message or message subset to the requesting application.

In another embodiment of the invention, a message queuing data processing system can be provided. The system can include a host computing system including one or more computers, each with a processor and memory. The system further can include a message queue coupled to the host computing system. Finally, a message retrieval module can execute in the host computing system. The module can include program code enabled to receive from a requesting application a message retrieval request for a message in a message queue storing different messages, to determine from the message retrieval request both a template defining fields in the messages, and also selection criteria operable upon content stored in at least one of the fields in the messages, to apply the selection criteria to the messages in the message queue to select a message or subset of the messages in the message queue, and to transmit the message or subset to the requesting application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for message queue retrieval by selection criteria;

FIG. 2 is a schematic illustration of a messaging queuing data processing system configured for message queue retrieval by selection criteria; and,

FIG. 3 is a flow chart illustrating a process for message queue retrieval by selection criteria.

### DETAILED DESCRIPTION OF THE INVENTION

Embodiments of the present invention provide a method, system and computer program product for message queue retrieval by selection criteria. In accordance with an embodiment of the present invention, a retrieval request can be received specifying each of a template and selection criteria for retrieving a message from the message queue. The template can specify different fields of a message in a message queue and can be used by the retrieval mechanism for the message queue to retrieve only a specified message meeting specified selection criteria. As such, the specified template can be used to locate a message with content in one or more fields meeting the selection criteria. One or more messages in the message queue containing data meeting the selection criteria can be retrieved from the message queue and returned to the calling application. In this way, the message queue paradigm can be expanded and enriched in functionality and efficiency by not requiring a calling application to retrieve all messages in a message queue to locate messages of interest.

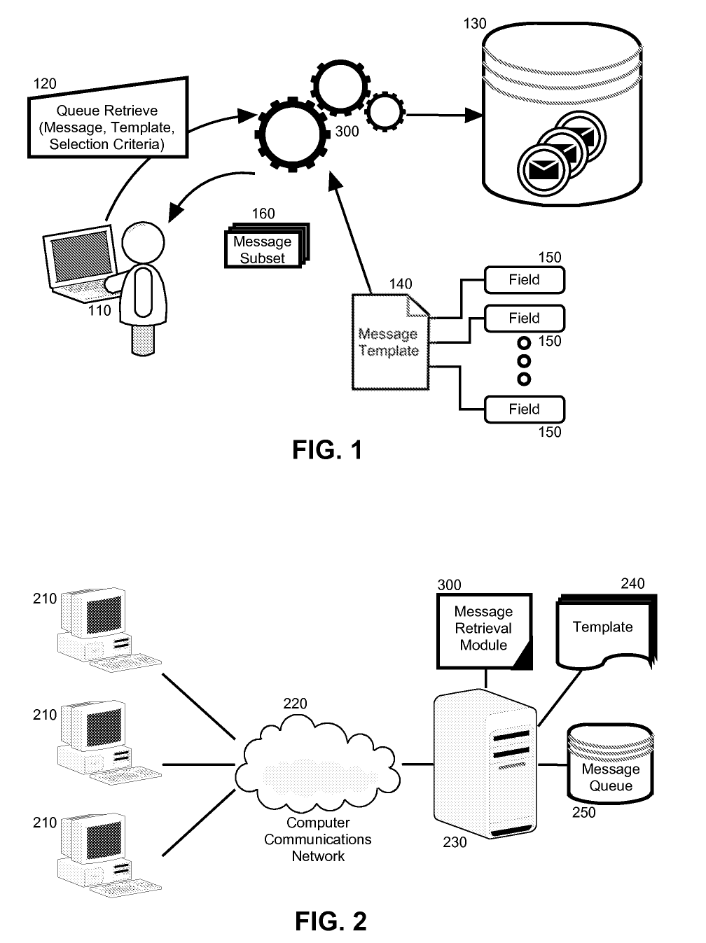

In further illustration, FIG. 1 pictorially shows a process for message queue retrieval by selection criteria. As shown in FIG. 1, a calling application 110 can issue a message retrieval request 120 for one or more messages in a message queue 130. Message retrieval module 300 can receive the request 120 and identify within the request a specification of a message template 140 or the request can include the message template 140 as part of the request. The message template 140 can indicate one or more different fields 150 in a message in the message queue 130. For example, each of the fields 150 can include a name or other identifier, an index into the message, and a length such that the data present in the message at the index and continuing for the length can map to the field 150.

The message retrieval module 300 yet further can identify within the request one or more criteria pertaining to the fields 150. In this regard, the criteria can be selection criteria specifying values of interest for content within one or more of the fields 150 of messages in the message queue 130. Thereafter, the message retrieval module 300 can apply the criteria to specified fields of each message in the message queue 130 to identify a message subset 160 of one or more messages with content in the specified fields meeting the criteria of the request 120. In this regard, to the extent the message template 140 maps portions of the messages in the message queue 130 to the fields 150 in the message template 140, selection criteria can be extracted from the request 120 for operation upon the mapped portions of the mapped content in the messages in the message queue 130. Finally, the message retrieval module 300 can return the message subset 160 to the calling application 110.

The process described in connection with FIG. 1 can be implemented within a message queuing data processing system. In further illustration, FIG. 2 schematically depicts a messaging queuing data processing system configured for message queue retrieval by selection criteria. The system can include one or more different client computing devices 210 communicatively coupled to a host computing system 230 over a computer communications network 220. The host computing system 230 can include one or more computing servers, each with memory and one or more processors and can support the operation of a message queue 250 such that requests for queued messages therein can be managed through the host computing system 230 and requested messages in the message queue 250 can be provided to applications executing in the client computing devices 210 requesting queued messages.

Message retrieval module 300 can execute as program code in memory by a processor in the host computing system 230. In this regard, message retrieval module 300 can include program code enabled to receive message retrieval requests from applications in the client computing devices 210 and to determine whether or not each of the requests specifies a message template 240 or includes a message template 240. The message template 240 can specify one or more fields in a message in the message queue 250, for instance by index and length. The program code of the message retrieval module 300 further can be enabled to identify within each of the requests where a message template 240 has been specified one or more criteria pertaining to the fields. In this regard, the criteria can be selection criteria specifying values of interest for content within one or more of the fields of messages in the message queue 250.

Even yet further, the program code of the message retrieval module 300 can be enabled to apply the criteria for each message request to specified fields of each message in the message queue 250 to identify a message subset of one or more messages within the message queue 250 with content in the specified fields meeting the criteria of the message request. Finally, the program code of the message retrieval module 300 can be enabled to return the message subset for each message request in which a message template has been specified to a corresponding requesting one of the applications in the client computing devices 210.

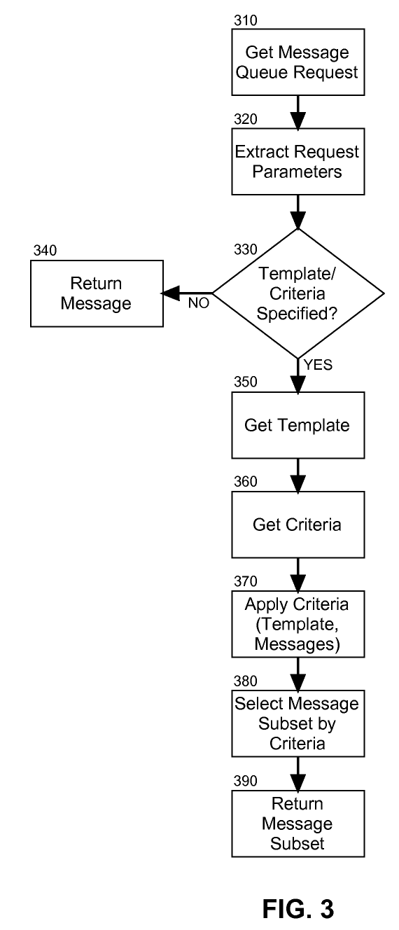

In yet further illustration of the operation of the message retrieval module 300, FIG. 3 is a flow chart illustrating a process for message queue retrieval by selection criteria. Beginning in block 310, a message retrieval request can be received from a requesting application to retrieve one or more messages from a message queue. The message retrieval request can include as an option a number of parameters, including the specification of a template or an actual template for messages in the message queue, as well as selection criteria pertaining to the content of different fields of the messages in the message queue. As such, in block 320, parameters can be extracted from the message retrieval request to determine whether or not a template has been specified or included as part of the request.

In decision block 330, if no template has been specified in or included as part of the message retrieval request, in block 340 a message can be retrieved from the message queue without regard to the content of the message and the retrieved message can be returned to the requesting application. Otherwise, the process can continue through block 350. In block 350, a template specified by the message request or included as part of the message request can be retrieved and loaded into memory in order to map particular fields to portions of the messages in the message queue. Also, in block 360, one or more message selection criteria can be retrieved from the message retrieval request.

The selection criteria can provide criteria for which content in a specified field of a message (according to the template) can meet or not meet. Examples include whether or not the content in one field matches, is greater than, less then or merely different than the content in another field, whether the content is a string matching partially or fully a specified string, or includes a specified string, whether the content has a value that exceeds or falls below a threshold, is equivalent to a specified value, is not equivalent to a specified value, or falls within a range of values, to name only a few examples. In any case, in block 370, the selection criteria can be applied to content in different fields of the messages in the message queue in order to identify messages with content meeting the selection criteria. Thereafter, in block 380 a subset of one or more messages with content in one or more fields meeting the selection criteria can be selected. Finally, in block 390, the message subset can be returned to the requesting application.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for message queue retrieval by selection criteria comprising:
receiving from a requesting application a message retrieval request for a message in a message queue storing a plurality of messages;
determining from the message retrieval request both a template defining fields in the messages, and also selection criteria operable upon content stored in at least one of the fields in the messages;
applying the selection criteria to the messages in the message queue to select a message subset of the messages in the message queue; and,
transmitting the message subset to the requesting application.

2. The method of claim 1, wherein determining from the message retrieval request both a template defining fields in the messages, and also selection criteria operable upon content stored in at least one of the fields in the messages, comprises:
identifying from the message retrieval request a specified template;
loading the specified template in memory;
mapping portions of the messages to the fields in the template; and,
extracting selection criteria from the message retrieval request operable upon the mapped portions of the mapped content.

3. The method of claim 1, wherein determining from the message retrieval request both a template defining fields in the messages, and also selection criteria operable upon content stored in at least one of the fields in the messages, comprises:
identifying from the message retrieval request a specified template included as part of the request;
loading the specified template in memory;
mapping portions of the messages to the fields in the template; and,
extracting selection criteria from the message retrieval request operable upon the mapped portions of the mapped content.

4. The method of claim 1, wherein applying the selection criteria to the messages in the message queue to select a message subset of the messages in the message queue, comprises:
comparing a value of content in a field specified by the selection criteria in each of the messages to a fixed value specified by the selection criteria; and,
selecting messages in the message queue for inclusion in the message subset, each of the selected messages in the message subset comprising a value of content in the field specified by the selection criteria matching the fixed value specified by the selection criteria.

5. The method of claim 1, wherein applying the selection criteria to the messages in the message queue to select a message subset of the messages in the message queue, comprises:
comparing a value of content in a field specified by the selection criteria in each of the messages to a range of values specified by the selection criteria; and,
selecting messages in the message queue for inclusion in the message subset, each of the selected messages in the message subset comprising a value of content in the field specified by the selection criteria matching a value falling amongst the range of values specified by the selection criteria.

6. The method of claim 1, wherein applying the selection criteria to the messages in the message queue to select a message subset of the messages in the message queue, comprises:
comparing a value of content in a first field specified by the selection criteria in each of the messages to a value of content in a second field specified by the selection criteria; and,
selecting messages in the message queue for inclusion in the message subset, each of the selected messages in the message subset comprising a value of content in the first field specified by the selection criteria matching the value of the second field specified by the selection criteria.

7. The method of claim 1, wherein applying the selection criteria to the messages in the message queue to select a message subset of the messages in the message queue, comprises:
comparing a value of content in a field specified by the selection criteria in each of the messages to a fixed value specified by the selection criteria; and,
selecting messages in the message queue for inclusion in the message subset, each of the selected messages in the message subset comprising a value of content in the field specified by the selection criteria not matching the fixed value specified by the selection criteria.

8. The method of claim 1, wherein applying the selection criteria to the messages in the message queue to select a message subset of the messages in the message queue, comprises:
comparing a value of content in a field specified by the selection criteria in each of the messages to a range of values specified by the selection criteria; and,
selecting messages in the message queue for inclusion in the message subset, each of the selected messages in the message subset comprising a value of content in the field specified by the selection criteria not matching a value falling within the range of values specified by the selection criteria.

9. A message queuing data processing system comprising:
a host computing system comprising a processor and memory;
a message queue coupled to the host computing system; and,
a message retrieval module executing in the host computing system, the module comprising program code enabled to receive from a requesting application a message retrieval request for a message in a message queue storing a plurality of messages, to determine from the message retrieval request both a template defining fields in the messages, and also selection criteria operable upon content stored in at least one of the fields in the messages, to apply the selection criteria to the messages in the message queue to select a message subset of the messages in the message queue, and to transmit the message subset to the requesting application.

10. A computer program product comprising a computer usable medium embodying computer usable program code for message queue retrieval by selection criteria, the computer program product comprising:
computer usable program code for receiving from a requesting application a message retrieval request for a message in a message queue storing a plurality of messages;
computer usable program code for determining from the message retrieval request both a template defining fields in the messages, and also selection criteria operable upon content stored in at least one of the fields in the messages;
computer usable program code for applying the selection criteria to the messages in the message queue to select a message subset of the messages in the message queue; and,
computer usable program code for transmitting the message subset to the requesting application.

11. The computer program product of claim 10, wherein the computer usable program code for determining from the message retrieval request both a template defining fields in the messages, and also selection criteria operable upon content stored in at least one of the fields in the messages, comprises:
computer usable program code for identifying from the message retrieval request a specified template;
computer usable program code for loading the specified template in memory;
computer usable program code for mapping portions of the messages to the fields in the template; and,
computer usable program code for extracting selection criteria from the message retrieval request operable upon the mapped portions of the mapped content.

12. The computer program product of claim 10, wherein the computer usable program code for determining from the message retrieval request both a template defining fields in the messages, and also selection criteria operable upon content stored in at least one of the fields in the messages, comprises:
computer usable program code for identifying from the message retrieval request a specified template included as part of the request;
computer usable program code for loading the specified template in memory;
computer usable program code for mapping portions of the messages to the fields in the template; and,
computer usable program code for extracting selection criteria from the message retrieval request operable upon the mapped portions of the mapped content.

13. The computer program product of claim 10, wherein the computer usable program code for applying the selection criteria to the messages in the message queue to select a message subset of the messages in the message queue, comprises:
computer usable program code for comparing a value of content in a field specified by the selection criteria in each of the messages to a fixed value specified by the selection criteria; and,
computer usable program code for selecting messages in the message queue for inclusion in the message subset, each of the selected messages in the message subset comprising a value of content in the field specified by the selection criteria matching the fixed value specified by the selection criteria.

14. The computer program product of claim 10, wherein the computer usable program code for applying the selection criteria to the messages in the message queue to select a message subset of the messages in the message queue, comprises:
computer usable program code for comparing a value of content in a field specified by the selection criteria in each of the messages to a range of values specified by the selection criteria; and,
computer usable program code for selecting messages in the message queue for inclusion in the message subset, each of the selected messages in the message subset comprising a value of content in the field specified by the selection criteria matching a value falling amongst the range of values specified by the selection criteria.

15. The computer program product of claim 10, wherein the computer usable program code for applying the selection criteria to the messages in the message queue to select a message subset of the messages in the message queue, comprises:
computer usable program code for comparing a value of content in a first field specified by the selection criteria in each of the messages to a value of content in a second field specified by the selection criteria; and,
computer usable program code for selecting messages in the message queue for inclusion in the message subset, each of the selected messages in the message subset comprising a value of content in the first field specified by the selection criteria matching the value of the second field specified by the selection criteria.

16. The computer program product of claim 10, wherein the computer usable program code for applying the selection criteria to the messages in the message queue to select a message subset of the messages in the message queue, comprises:
computer usable program code for comparing a value of content in a field specified by the selection criteria in each of the messages to a fixed value specified by the selection criteria; and,
computer usable program code for selecting messages in the message queue for inclusion in the message subset, each of the selected messages in the message subset comprising a value of content in the field specified by the selection criteria not matching the fixed value specified by the selection criteria.

17. The computer program product of claim 10, wherein the computer usable program code for applying the selection criteria to the messages in the message queue to select a message subset of the messages in the message queue, comprises:
computer usable program code for comparing a value of content in a field specified by the selection criteria in each of the messages to a range of values specified by the selection criteria; and,
computer usable program code for selecting messages in the message queue for inclusion in the message subset, each of the selected messages in the message subset comprising a value of content in the field specified by the selection criteria not matching a value falling within the range of values specified by the selection criteria.
